(19) United States
(12) Patent Application Publication
(10) Pub. No.: US 2026/0292038 A1
(43) Pub. Date: Sep. 24, 2026

(54) NETWORK DEVICE, CONTROL METHOD FOR NETWORK DEVICE, AND RECORDING MEDIUM

(71) Applicant: CANON KABUSHIKI KAISHA, Tokyo (JP)

(72) Inventor: SATOSHI TAMURA, Kanagawa (JP)

(21) Appl. No.: 19/563,049

(22) Filed: Mar. 11, 2026

(30) Foreign Application Priority Data
Mar. 18, 2025 (JP) 2025-043873

(51) Int. Cl. H04L 67/55

(52) U.S. Cl. CPC H04L 67/55

(57) ABSTRACT

An image forming apparatus that provides a website including information for the image forming apparatus itself provides an application having at least a portion of functions of the website to an information terminal that has accessed the website and executes a notification processing for causing the application installed in the information terminal to perform notifications for information regarding a network device via a push service. The application provided by the image forming apparatus is a PWA for managing the image forming apparatus, and in the PWA, access information corresponding to a screen to be accessed when a notification for information regarding the image forming apparatus based on the notifying process is tapped is generated based on information regarding the image forming apparatus included in the notification.

### BACKGROUND

### Field of the Technology

The present disclosure relates to event notification in device management using a PWA.

### Description of the Related Art

Conventionally, device management systems have been constructed that perform management of information and statuses of network equipment (hereinafter also referred to as “network devices”) such as printers. In a device management system, device management has been realized by installing an application program for device management (hereinafter, also referred to as a “device management application”) in an information terminal and collecting information from network devices that exist on a network. In a case in which a failure occurs in a network device, the device management application receives a notification transmitted from the network device indicating the failure, thereby making it possible to manage the occurrence status of the failure or to notify a user via email. In this context, as a new application program, there is a technology called a Progressive Web App (hereinafter, also referred to as a “PWA”). This is a type of web application. Japanese Patent Application Laid-Open No. 2022-517891 discloses generating push notification content, which is transmitted by a system using PWA technology, based on recognized patterns.

However, Japanese Patent Application Laid-Open No. 2022-517891 does not assume realizing functionality provided by a device management application using PWA technology. Additionally, in a conventional device management application, notifications are performed to a e-mail address of a device administrator via email and the like in relation to events such as failures occurring in a network device. To display a device management screen from an email notification, a plurality of operations is required, which include receiving the email notification, starting up an email program, opening the target email, launching a browser via a URL that is described in the email, and displaying the device management screen. The device administrator comes to understand the content of the event information for which notification has been performed by performing multiple operations. Therefore, improvement of the convenience of event notification during device management is required, such as displaying the device management screen without the need to perform multiple operations from the event notification from the network device by utilizing PWA technology.

### SUMMARY

The present disclosure provides a highly convenient event notification mechanism for device management using a PWA.

A network device of the present disclosure is a network device that provides a website including information about the network device itself, the network device comprising a providing unit configured to provide, to a terminal that has accessed the website, an application having at least a portion of functions of the website, and a notifying unit configured to execute a notification process for causing the application installed in the terminal to provide notifications for information regarding the network device via a push service, wherein the application provided by the network device is a progressive web application for managing the network device, and in the application, access information corresponding to a screen to be accessed in a case in which a notification for information regarding the network device based on the notifying process is tapped is generated based on information regarding the network device included in the notification.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the configuration of an information processing system.

FIG. 2 is a diagram illustrating an example of a hardware configuration of an image forming apparatus 101.

FIG. 3A and FIG. 3B are diagrams illustrating hardware configurations of an information terminal 102 and a push server 103.

FIG. 4A and FIG. 4B are diagrams illustrating software module configurations of the image forming apparatus 101 and the information terminal 102.

FIG. 5 is a diagram illustrating a software module configuration of a push server 103.

FIG. 6 is a sequence diagram explaining installation and subscription registration of a device management PWA.

FIG. 7 is a sequence diagram for push notifications in the device management PWA.

FIG. 8A and FIG. 8B are diagrams illustrating an example of a UI of the device management PWA.

FIG. 9A and FIG. 9B are diagrams illustrating an example of a UI of the device management PWA.

FIG. 10A and FIG. 10B are diagrams illustrating an example of a UI of the device management PWA

FIG. 11 is a flowchart illustrating a URL setting process for a push notifications in the second embodiment.

FIG. 12 is a diagram illustrating an example of a setting screen for push notifications in the second embodiment.

### DESCRIPTION OF THE EMBODIMENTS

### Embodiment 1

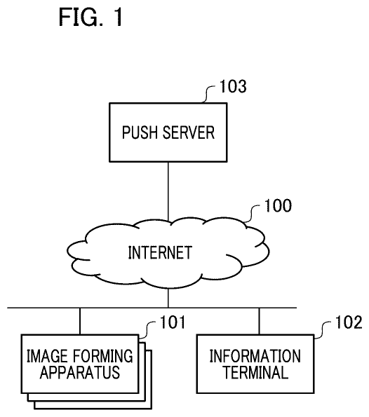

FIG. 1 is a diagram illustrating a configuration of an information processing system in the present embodiment. The information processing system in the present embodiment is a system that provides, via a push server, a notification regarding a network device to a terminal from the network device. The information processing system that provides the notification regarding the network device to the terminal from the network device is a part of a device management system that manages the network device. When the network device detects the occurrence of an event in the network device itself, the network device instructs the push server to transmit a notification of the occurrence of the event to a terminal registered as a notification destination. Upon receiving the notification from the network device, the push server provides a notification regarding the occurrence of the event in the network device to the terminal registered as the notification destination. Accordingly, a notification with respect to the occurrence of an event such as an error in the network device can be transmitted to a terminal of an administrator or a maintenance worker of the network device, and the occurrence of the event can be announced. The information processing system includes the network device, a push server 103 that provides a push service, and an information terminal 102 that uses a progressive web application as a notification transmission destination. Note that although in the present embodiment, a case in which the network device is the image forming apparatus 101 is explained as an example, the network device is not limited thereto. The network device may be any device capable of communication and may be, for example, a scanner, a 3D printer, a notebook computer, a smartphone, a smart home appliance, and the like.

Note that the information processing system in the present embodiment is realized using Progressive Web Apps (hereinafter, referred to as “PWA”). A PWA is a technology that enables a website to be used in a manner similar to that of a local application. In a case in which a website is compatible with a PWA, functions provided by an information processing system can be easily obtained and used via a web browser. In the present embodiment, a device management application realized by utilizing PWA technology is referred to as a “device management PWA” or “PWA”. A device management screen for managing the image forming apparatus 101 can be displayed in the device management PWA. The device management PWA utilizes a function of a Service Worker, which is a program (JavaScript) that defines behaviors including content for managing a network device, a push notification function, operation in an offline state, and display of an icon on a home screen. The Service Worker corresponding to the device management PWA is executed in the background independently of a web page that is accessed by a web browser of the information terminal 102 to obtain the device management PWA. Additionally, by utilizing a Service Worker function that is provided in a web browser, the device management PWA can perform event notification by push notification via an API through a push service from an application server of the image forming apparatus 101. The Service Worker forms part of the configuration of the PWA and is provided as part of an RUI provided by the image forming apparatus 101. The Service Worker of the information terminal 102 can receive a push notification from the image forming apparatus 101 and perform notifications relating to event information via an operating system (OS) of the information terminal on which the device management PWA is executed.

The image forming apparatus 101 is a network device that serves as a notification source. The image forming apparatus 101 provides, via a push service, information related to the image forming apparatus 101 to the PWA that is provided by the image forming apparatus 101 and installed in the information terminal 102. Therefore, when the image forming apparatus 101 detects the occurrence of an event, such as an error, the image forming apparatus 101 requests the push server 103 to send an event notification to the information terminal 102. Additionally, the image forming apparatus 101 provides a website including information for the image forming apparatus 101 itself. The image forming apparatus 101 is, for example, a Multifunction Peripheral (MFP) having a printing function and a scanning function. By the printing function, the image forming apparatus 101 receives print data via a network and performs printing on an actual sheet and the like using known printing technology, such as electrophotography or ink-jet technology. By the scanning function, the image forming apparatus 101 reads a paper document via a scanner and converts the paper original into image data. Note that the image forming apparatus 101 may be a single-function printer having only a printing function.

The information terminal 102 is an information terminal for receiving notifications about the occurrence of events in the image forming apparatus 101 that is a management target. The information terminal 102 is, for example, a terminal for use by an administrator of the image forming apparatus 101 or a worker in charge of maintenance of the image forming apparatus 101, and a user such as a manager can receive and confirm notifications regarding the image forming apparatus 101 at the information terminal 102. A web browser 451 is installed in the information terminal 102, and a progressive web application (PWA) can be used. The information terminal 102 accesses a website including information for the image forming apparatus 101 that is provided by the image forming apparatus 101, and, via the web browser 451, installs a progressive web application having at least a portion of functions of the website. A Service Worker is installed 311 in the web browser 451. Additionally, the information terminal 102 is registered in the push server 103 as a notification target of the image forming apparatus 101. The information terminal 102 is, for example, a smartphone. Note that the information terminal 102 may be any terminal that is capable of receiving an event, and may be a personal computer, a tablet, and the like.

The push server 103 is an information processing apparatus that provides a push service. The push service realizes push notifications to the information terminal 102 from a notification transmission unit 408, which is an application server of the image forming apparatus 101. In the push server 103, for example, a notification destination for a notification from the image forming apparatus 101 is registered in advance. In the present embodiment, the information terminal 102 is registered in the push server 103 as a notification destination for notifications transmitted from the image forming apparatus 101. The push server 103 transmits notifications from the image forming apparatus 101 to the information terminal 102 that is registered as the notification destination for the notifications from the image forming apparatus 101. Note that the push server 103 may be realized by one or a plurality of information processing apparatuses, a virtual machine (cloud service) using resources provided by a data center including information processing apparatuses, or a combination thereof.

The Internet 100 is an example of a network that connects the image forming apparatus 101, the information terminal 102, and the push server 103. The Internet 100 may be configured in any manner as long as data transmission and reception are possible, and the communication method thereof is not limited. For example, the Internet 100 may be configured by a LAN, a WAN, a cellular network such as LTE or 5G, a wireless network, a telephone line, a dedicated digital line, or a combination thereof.

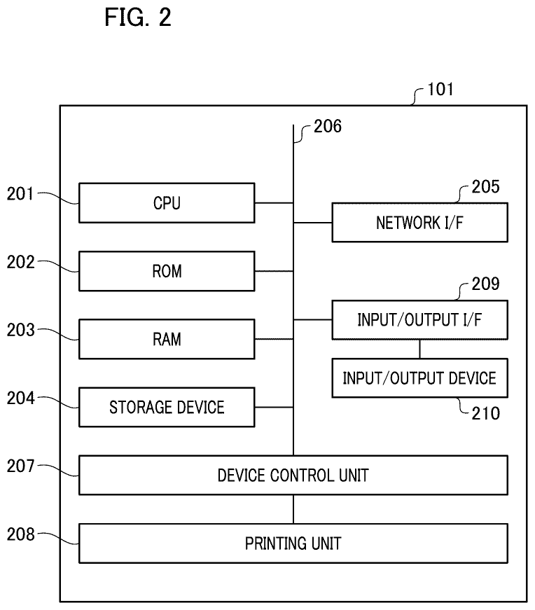

FIG. 2 is a diagram illustrating a hardware configuration of the image forming apparatus 101. The image forming apparatus 101 includes a CPU 201, a ROM 202, a RAM 203, a storage device 204, a network I/F 205, an internal bus 206, a device control unit 207, a printing unit 208, an input/output I/F 209, and an input/output device 210.

A Central Processing Unit (CPU) 201 controls the entire image forming apparatus 101 by comprehensively controlling each device via the internal bus 206. The Read Only Memory (ROM) 202 stores programs including a basic control program for the image forming apparatus 101. The Random Access Memory (RAM) 203 functions as a memory and a work area for the CPU 201. Additionally, the RAM 203 stores event information generated in the image forming apparatus 101, various types of counter information, consumption level information for consumable parts, various types of logs, and the like. The storage device 204 is an external storage apparatus such as a Hard Disk Drive (HDD) or a Solid State Drive (SSD). The storage device 204 stores programs, image data, and the like. Additionally, the storage device 204 may store event information, various types of counter information, consumption level information for consumable parts, and various types of logs, instead of the RAM 203. The CPU 201 comprehensively controls each component connected to the system bus 206 by executing a program stored in memory (ROM 202, and the storage device 204).

The network I/F 205 exchanges data unidirectionally or bidirectionally with an external apparatus, such as the information terminal 102 or the push server 103, via the Internet 100. The device control unit 207 controls the printing unit 208 in accordance with printing requests and the like. The printing unit 208 prints an original document that has been read by a reader, and image data that has been stored in the storage device 204 on a recording medium (for example, on a sheet of paper). Additionally, the image forming apparatus 101 may include a scanner unit that reads a paper document through a scanner and converts the paper original document into image data. The CPU 201 performs program execution processing in cooperation with the ROM 202 and the RAM 203, and also performs processing for recording image data on a recording medium, such as the storage device 204. The input/output device 210 receives input from a user (print instruction, scan instruction, button input, and the like). The input/output I/F 209 transmits the user input received by the input/output device 210 to each processing unit. The CPU 201, the ROM 202, the RAM 203, the storage device 204, the network I/F 205, and the device control unit 207 are connected to the internal bus 206.

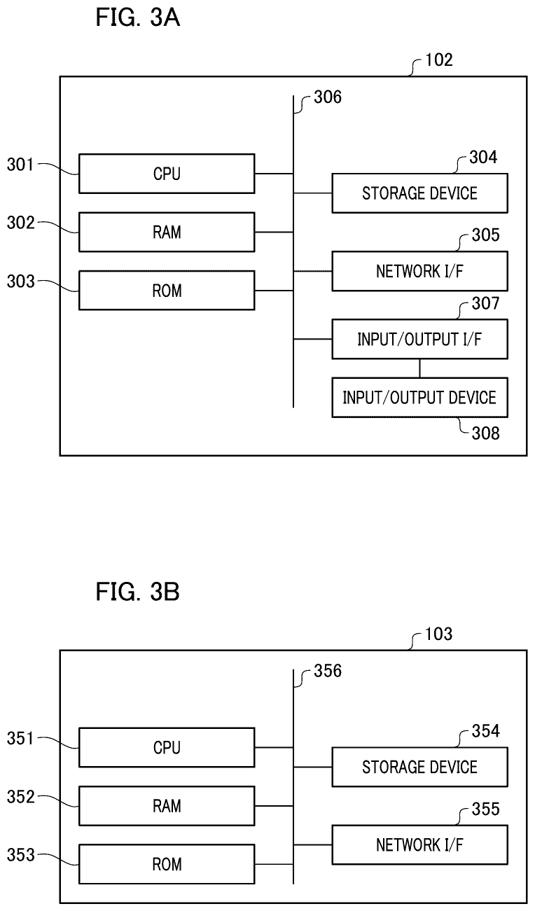

FIG. 3A is a diagram illustrating a hardware configuration of the information terminal 102. The information terminal 102 includes a CPU 301, a RAM 302, a ROM 303, a storage device 304, a network I/F 305, an internal bus 306, an input/output I/F 307, and an input/output device 308. The CPU 301 controls the entire information terminal 102 by comprehensively controlling each component via the internal bus 306. The ROM 303 stores programs and the like. The RAM 302 functions as a memory and a work area for the CPU 301. The CPU 301 executes various types of control processing by expanding a program stored in the ROM 303 into the RAM 302 and executing the program. The storage device 304 stores programs and various types of information. Additionally, the storage device 304 may store various types of information in place of the RAM 302.

The network I/F 305 exchanges data unidirectionally or bidirectionally with an external apparatus, such as the image forming apparatus 101 or the push server 103, via the Internet 100. Each component of the information terminal 102 is connected to the internal bus 306. The input/output device 308 is an operation unit, such as a touch panel. The input/output device 308 receives input from a user. Additionally, the input/output device 308 displays a screen to the user. The input/output I/F 307 connects each component of the information terminal 102 and the input/output device 308. The input/output I/F 307 controls input from the input/output device 308 and output to the input/output device 308.

FIG. 3B is a diagram illustrating a hardware configuration of the push server 103. The push server 103 includes a CPU 351, a RAM 352, a ROM 353, a storage device 354, a network I/F 355, and an internal bus 356. The CPU 351 controls the entire push server 103 by comprehensively controlling each component via the internal bus 356. The ROM 353 stores programs, and the like. The RAM 352 functions as a memory and a work area for the CPU 351. The CPU 351 executes various types of control processing by expanding a program stored in the ROM 353 into the RAM 352 and executing the program.

The storage device 354 stores programs, image data, and various types of information. The push server 103 can communicate with the image forming apparatus 101 and the information terminal 102 via the Internet 100 through the network I/F 355. The RAM 352, the ROM 353, the storage device 354, and the network I/F 355 are connected to the internal bus 356.

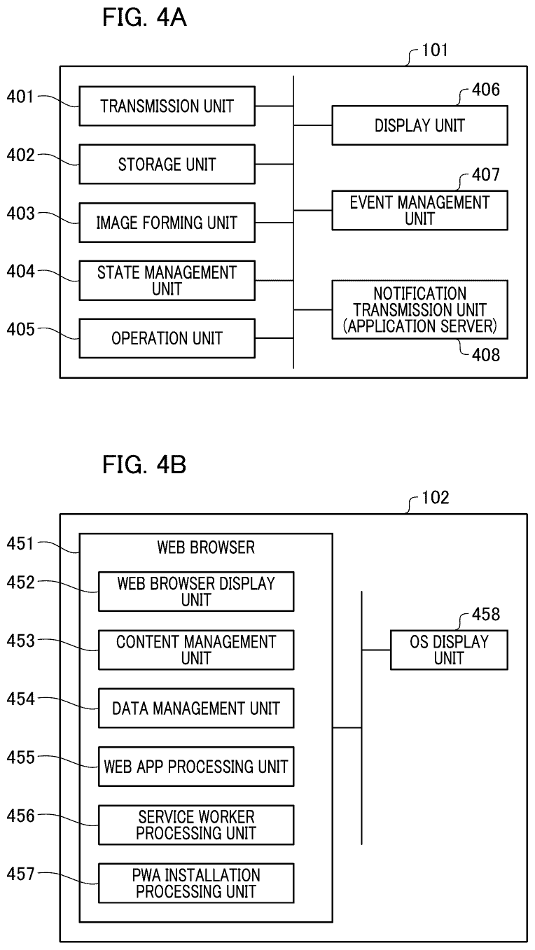

FIG. 4A and FIG. 4B are diagrams explaining examples of software module configurations of the image forming apparatus 101 and the information terminal 102. FIG. 4A is a diagram explaining a software module configuration of the image forming apparatus 101. The software modules of the image forming apparatus 101 are executed by the CPU 201 reading a program from the ROM 202 and executing the program. The image forming apparatus 101 includes a transmission unit 401, a storage unit 402, an image forming section 403, a status management unit 404, an operation unit 405, a display unit 406, an event management unit 407, and the notification transmission unit 408.

The transmission unit 401 collects device information and event information generated in the image forming apparatus 101 and transmits the collected information to an external apparatus (not illustrated). The transmission unit 401 obtains information relating to the image forming apparatus 101 (hereinafter, referred to as “device information”), various types of counter information, consumption level information for consumable parts, and the like from the storage device 204. The device information includes identification information (such as a serial number), network information (such as an IP address), operation information, and the like for the image forming apparatus 101. For example, an HTTPS communication protocol is used for data transmission and reception by the image forming apparatus 101.

The storage unit 402 controls saving and reading of information to and from the ROM 202, the RAM 203, and the storage device 204. Additionally, the storage unit 402 stores management information necessary for management of the image forming apparatus 101. The management information includes, for example, firmware information, device information such as an identification number of the image forming apparatus 101, various types of counter information, consumption level information of consumable parts, an operation history of the image forming apparatus 101, and history information (log data) representing various abnormal statuses. Furthermore, the management information includes information regarding the push server 103 and information regarding the information terminal 102 registered as a target of push notification as a notification destination of an event occurrence notification.

The image forming section 403 generates print data and outputs the generated print data to the printing unit 208. The status management unit 404 manages a status of the image forming apparatus 101. For example, the status management unit 404 manages abnormal statuses of the image forming apparatus 101. Additionally, the status management unit 404 manages counter information and notification information. The counter information includes, for example, a value obtained by counting the number of printed sheets printed by the image forming apparatus 101 using a sensor and the like, and consumption level information indicating a consumption level of parts or a remaining amount of consumables such as a toner bottle. Additionally, the status management unit 404 performs print control.

The operation unit 405 receives operating instructions for the image forming apparatus 101 from a user, including a print instruction. The display unit 406 controls display of a UI screen relating to the image forming apparatus 101 to the user. For example, the display unit 406 controls display of a UI screen displaying condition information for the image forming apparatus 101, consumption rate information for various consumables (including toner remaining amount information), setting information, and the like.

The event management unit 407 creates and manages event information upon receiving an event, such as an abnormality occurring in the image forming apparatus 101. The event information that is managed by the event management unit 407 includes events relating to print jobs issued by a user of the image forming apparatus 101, abnormalities (failures, errors, and the like), general status information for the image forming apparatus 101, and the like. For example, errors of the image forming apparatus 101 include errors with high urgency, such as a hard disk error or a paper jam, and warning-level errors, such as a low-toner condition. In a case in which the event management unit 407 detects the occurrence of an event and creates event information, the event management unit 407 instructs (requests) the notification transmission unit 408 to perform notification of the event. Additionally, the event management unit 407 may determine whether or not the event that was detected by the event management unit 407 is a notification target for the device management PWA, and, in a case in which the event is determined to be a notification target, may issue an instruction to the notification transmission unit 408 to transmit an event notification.

The notification transmission unit 408 is an application server that performs notification to the information terminal 102, which is a notification target, via the push server 103. The notification transmission unit 408 first edits information into a format for performing push notification based on an instruction from the event management unit 407. The notification transmission unit 408 then transmits a notification request to the push server 103 for the information terminal 102 that is registered as a notification target. Thus, the notification transmission unit 408 functions as a notification unit for executing notifying processing for causing a PWA that is installed in the information terminal 102 to perform notification of information relating to the image forming apparatus 101 via a push service. Upon receiving an event occurrence notification for the information terminal 102 from the notification transmission unit 408 of the image forming apparatus 101, the push server 103 transmits, by push notification, information for notifications from the image forming apparatus 101 to the information terminal 102. Additionally, the notification transmission unit 408 is an application server (web server) that generates and provides a Web page (website) to be displayed on the web browser 451 of the information terminal 102. In the present embodiment, the notification transmission unit 408 provides a screen for managing the image forming apparatus 101. The notification transmission unit 408 provides, to the information terminal 102 that has accessed the Web page (website), a device management PWA having at least a portion of the functions of the website.

FIG. 4B is a diagram explaining a software module configuration of the information terminal 102. The software modules of the information terminal 102 are realized by the CPU 301 reading a program from the ROM 303 and executing the program. The information terminal 102 includes the web browser 451 and an OS display unit 458. The OS display unit 458 is a software module for displaying functions provided by an OS as a Graphical User Interface (GUI). The OS display unit 458 provides functions necessary for a user to operate the information terminal 102 via the GUI.

The web browser 451 includes a web browser display unit 452, a content management unit 453, a data management unit 454, a web application processing unit 455, a Service Worker processing unit 456, and a PWA installation processing unit 457. The web browser display unit 452 displays an RUI (Remote UI) provided by the image forming apparatus 101 on the information terminal 102. In the present embodiment, the RUI provided by the image forming apparatus 101 is provided as a web application (PWA), and the RUI is displayed on the web browser display unit 452.

The content management unit 453 obtains web content necessary for displaying the RUI on the web browser display unit 452. Additionally, the content management unit 453 performs transmission and reception of data of web content necessary for displaying the RUI on the web browser display unit 452. The web content includes, for example, Hyper Text Markup Language (HTML), JavaScript, Cascading Style Sheets (CSS), and the like. Furthermore, the web content also includes a Service Worker and a manifest file, which are constituent elements of a PWA. A Service Worker is a script that operates as a background process. A manifest file is a file in which installation settings for the PWA are described.

The data management unit 454 communicates with the image forming apparatus 101 and obtains device information, such as setting values in the image forming apparatus 101. Additionally, the data management unit 454 transmits information input to the RUI by a user to the image forming apparatus 101. The web application processing unit 455 analyzes various types of web content and data obtained from the image forming apparatus 101 and comprehensively controls behavior of a web application operating on the web browser 451. Additionally, the web application processing unit 455 controls processing for installing the PWA.

The Service Worker processing unit 456 registers, in the web browser 451, a Service Worker obtained by the content management unit 453 and causes the Service Worker to be executed in the background. The Service Worker processing unit 456 is a part of a program (script) provided as a PWA by the image forming apparatus 101 and is a software module that is executed on the information terminal 102 side. By the Service Worker operating in the background, functions such as improvement of RUI display speed by cache control, offline operation, background synchronization, push notifications, and the like can be realized. Additionally, the Service Worker processing unit 456 stores registration information for the Service Worker in the content management unit 453. Additionally, in a case in which cache control by the Service Worker is performed, the Service Worker processing unit 456 stores caches of various types of web content in the content management unit 453. In the present embodiment, the Service Worker processing unit 456 generates notification content to be displayed in the PWA based on a notification that has been received from an application server of the image forming apparatus 101 via the push server 103. As the notification content, the Service Worker processing unit 456 generates information indicating notification content, such as a notification title and a message relating to the notification, and access information, such as a Uniform Resource Locator (URL) for a web page that is relevant to the event to which the notification pertains. A URL included in a notification generated by the Service Worker processing unit 456 and displayed in the PWA is a URL for a screen to which transition occurs when the notification is clicked.

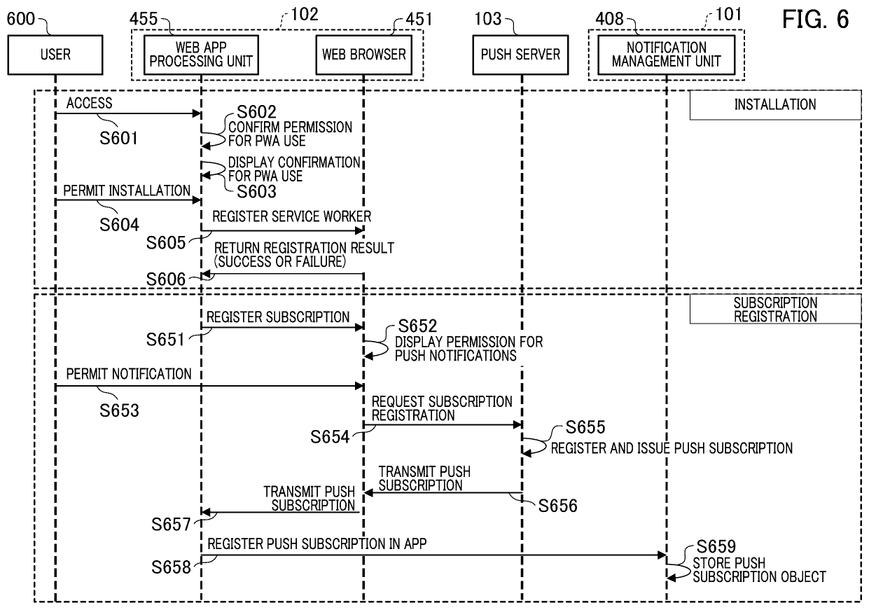

The PWA installation processing unit 457 performs processing relating to installation of a PWA. In the present embodiment, the PWA installation processing unit 457 installs, in the information terminal 102, a device management PWA having at least a portion of the functions of a website by accessing the website provided by the image forming apparatus 101. A PWA installation method and an installation sequence will be described below with reference to FIG. 6.

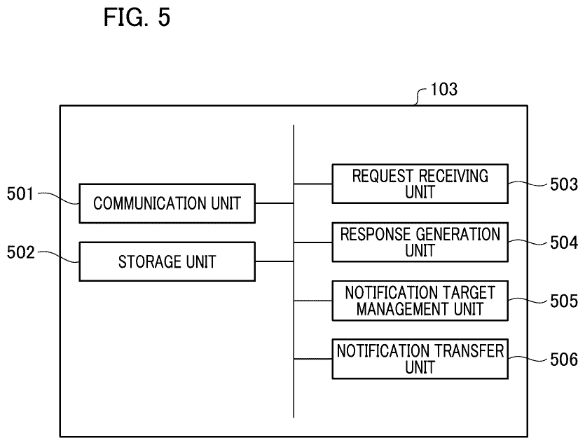

FIG. 5 is a diagram explaining a software module configuration of the push server 103. The software modules of the push server 103 are realized by the CPU 351 reading a program from the ROM 353 and executing the program. The push server 103 includes a communication unit 501, a storage unit 502, a request receiving unit 503, a response generating unit 504, a notification target management unit 505, and a notification transfer unit 506.

The communication unit 501 performs communication with the image forming apparatus 101 and the information terminal 102. For example, the communication unit 501 receives a push notification request transmitted from the image forming apparatus 101 or transfers a push notification request to the web browser 451 of the information terminal 102. The storage unit 502 performs storage control of information to and from the RAM 352, the ROM 353, and the storage device 354. In the present embodiment, targets of the storage control include information for a push notification target terminal, information for a push notification request, and the like.

The request receiving unit 503 receives requests from an external apparatus. For example, the request receiving unit 503 receives a registration request as a push notification target transmitted from the web browser 451 of the information terminal 102. Additionally, the request receiving unit 503 receives a push notification request, a notification suppression request, and a notification suppression cancellation request, from the notification transmission unit 408, which is an application server of the image forming apparatus 101.

The response generating unit 504 generates a response to a request for registration as a push notification target that has been received from the web browser 451. The response generating unit 504 generates a Push Subscription object as the response to the request for registration as a push notification target. The Push Subscription object includes information that is necessary when the notification transmission unit 408, which is an application server of the image forming apparatus 101, transmits a push notification to the web browser 451 of the information terminal 102, which is used by a user. The response generating unit 504 then transmits the generated response to the web browser 451, which is a request transmission source.

The notification target management unit 505 manages information for an information terminal registered as a push notification target. Specifically, the information includes an identifier for identifying a target terminal, a Push Subscription object, and the like. In the present embodiment, the notification target management unit 505 manages information for the information terminal 102 registered as a push notification target. The notification transfer unit 506 transfers a notification to a notification target terminal, based on endpoint information that is included in the push notification request that has been received from the notification transmission unit 408 of the image forming apparatus 101. In the present embodiment, the notification transfer unit 506 transfers the notification that has been received from the notification transmission unit 408 of the image forming apparatus 101 to the web browser 451 of the information terminal 102. The notifications include, for example, information regarding an error occurring in the image forming apparatus 101, information regarding a consumption level of consumables, and news from an administrator.

FIG. 6 is a sequence diagram explaining installation and subscription registration of a device management PWA. Note that although in the image forming apparatus 101 of the present embodiment, it is explained that a device administrator can set in advance whether or not to permit use of the RUI of the image forming apparatus 101 as a PWA, use of a PWA may be uniformly permitted. Additionally, in the present embodiment, the web browser 451 of the information terminal 102 is a browser capable of using a PWA. Additionally, in the present embodiment, it is assumed that a web page of an RUI that is provided by the image forming apparatus 101 is displayed on the GUI via the web application processing unit 455 of the information terminal 102, and the web page is compatible with a PWA.

Each processing that is executed by the image forming apparatus 101 in FIG. 6 is realized by the CPU 201 reading a program and the like stored in the ROM 202, and executing the program. Each processing that is executed by the information terminal 102 in FIG. 6 is realized by the CPU 301 reading a program and the like stored in the ROM 303, and executing the program. Each processing that is executed by the push server 103 in FIG. 6 is realized by the CPU 351 reading a program and the like stored in the ROM 353, and executing the program.

First, processing for installing a device management PWA onto the information terminal 102 in steps S601 to S606 will be described. In step S601, the web application processing unit 455 of the information terminal 102 receives a user operation for accessing a URL of an RUI for device management provided by the image forming apparatus 101. The web application processing unit 455 determines whether or not the web browser 451 of the information terminal 102 is a browser capable of using a PWA. In a case in which the web browser 451 is a browser capable of using a PWA, the web application processing unit 455 performs the processing for step S602. In the present embodiment, since the web browser 451 is a browser capable of using a PWA, the processing for step S602 is performed. Additionally, in step S601, when a user operation for accessing the URL of the RUI that is provided by the image forming apparatus 101 is received, the web browser 451 accesses, in parallel with processing performed by the web application processing unit 455, the URL that has been specified by the user. The web browser 451 then displays a web page of the RUI that is provided by the notification transmission unit 408, which is an application server of the image forming apparatus 101 on the input/output device 308 of the information terminal 102.

In step S602, the web application processing unit 455 confirms whether or not use of the RUI, which is provided by the image forming apparatus 101, as a PWA is permitted. In a case in which use of the RUI as a PWA is permitted, the web application processing unit 455 performs the processing for step S603. In step S603, the web application processing unit 455 displays a screen for confirming use of the PWA on the input/output device 308 of the information terminal 102. For example, the web application processing unit 455 superimposes a pop-up screen on the RUI displayed in the web browser 451 to confirm use of the PWA. The screen for confirming the use of the PWA displays, for example, a button for installing the PWA, and a button for not executing installation of the PWA, in order to receive a user selection.

In step S604, the web application processing unit 455 receives a user selection on the screen for confirming the use of the PWA. In the present embodiment, it is assumed that installation of the PWA is permitted by the user. The web application processing unit 455 detects that the user has pressed the PWA installation button, determines that installation of the PWA is permitted by the user, installs the PWA from the website (Web page) that is provided by the image forming apparatus 101, and performs the processing for step S605.

In step S605, the web application processing unit 455 registers a Service Worker in the web browser 451. In step S606, the web browser 451 returns the Service Worker registration result (success or failure) to the Web application processing unit 455 and the web page. In the present embodiment, it is assumed that the registration of the Service Worker to the web browser 451 is successful.

Through the above processing, a Service Worker necessary for making a web page of an RUI usable as a PWA is downloaded to the web browser 451, and the web page of the RUI becomes usable as a PWA. In the present embodiment, the information terminal 102 is capable of accessing a website of an RUI through which the image forming apparatus 101 provides information for the image forming apparatus 101 itself, and using, on the information terminal 102, a device management PWA having at least a portion of the functions of the website. In a case in which the registration processing for the Service Worker is successful and a device management PWA including a Service Worker is installed in the information terminal 102, the web application processing unit 455 proceeds to the next registration processing for a push notification target terminal.

Next, in steps S651 to S659, registration processing for a push notification target terminal will be explained. In step S651, the web application processing unit 455 issues a request to the web browser 451 to register (subscription registration) the information terminal 102 as a push notification target terminal. In step S652, the web browser 451 displays, to a user, a screen for confirming permission for push notifications. On the screen for confirming permission for push notifications, for example, a push notification permission button and a push notification rejection button for receiving a user selection are displayed.

In step S653, the web browser 451 receives a user selection to permit or reject push notifications. In the present embodiment, it is assumed that the push notification permission button is selected by the user. Accordingly, the web browser 451 receives permission for push notifications from the user. In a case in which push notifications are permitted, the web browser 451 performs the processing for step S654. In step S654, the web browser 451 transmits a request to the push server 103 to register (subscription registration) the web browser 451 of the information terminal 102 as a push notification target for the image forming apparatus 101. Upon receiving the registration request as a push notification target from the information terminal 102, the request receiving unit 503 of the push server 103 notifies the notification target management unit 505. Upon receiving the notification of the registration request as a push notification target from the information terminal 102, the notification target management unit 505 performs the processing for step S655.

In step S655, the notification target management unit 505 registers, in the push server 103, the information terminal 102 that has submitted a registration request as a push notification target, as a push notification target terminal for receiving push notifications from the image forming apparatus 101. Additionally, the notification target management unit 505 issues a Push Subscription object as a response to the registration request as a push notification target from the information terminal 102. A Push Subscription object associates a sender and a receiver of a push notification. The Push Subscription object includes information that is necessary when the notification transmission unit 408, which is an application server of the image forming apparatus 101, transmits a push notification to the web browser 451 of the information terminal 102, which is used by a user. Specifically, the Push Subscription object includes endpoint information that is necessary when the notification transmission unit 408 issues a push notification request to a Service Worker of a notification target terminal via the push server 103. Endpoint information for the push server 103 is composed of a URL of the push server 103 and endpoint text that differs for each terminal. For example, the endpoint information of the push server 103 is “endpoint”:
https://test.pushserver.com/send/testEndPoint0001.

In step S656, the response generating unit 504 of the push server 103 transmits a response to the request for registering the information terminal 102 as a push notification target to the web browser 451, which is a request transmission source. Specifically, the response generating unit 504 transmits, as the response, the Push Subscription object that was issued in step S655 to the web browser 451, which is the request transmission source.

In step S657, the web browser 451 that has received the Push Subscription object from the push server 103 transfers the Push Subscription object to the web application processing unit 455, which is a request source. In step S658, the web application processing unit 455 transmits the received Push Subscription object to the notification transmission unit 408, which is an application server of the image forming apparatus 101, for registration. In step S659, upon receiving the Push Subscription object from the information terminal 102, the notification transmission unit 408 of the image forming apparatus 101 stores the Push Subscription object in the storage unit 502. The Push Subscription object that is stored therein is used when transmitting a push notification request for a target terminal (the information terminal 102) to the push server 103. Through the processing described above, registration processing of the information terminal 102 as a push notification target terminal is completed, and it becomes possible to provide notifications of information relating to the image forming apparatus 101 to the PWA of the information terminal 102 from the image forming apparatus 101 via the push server 103.

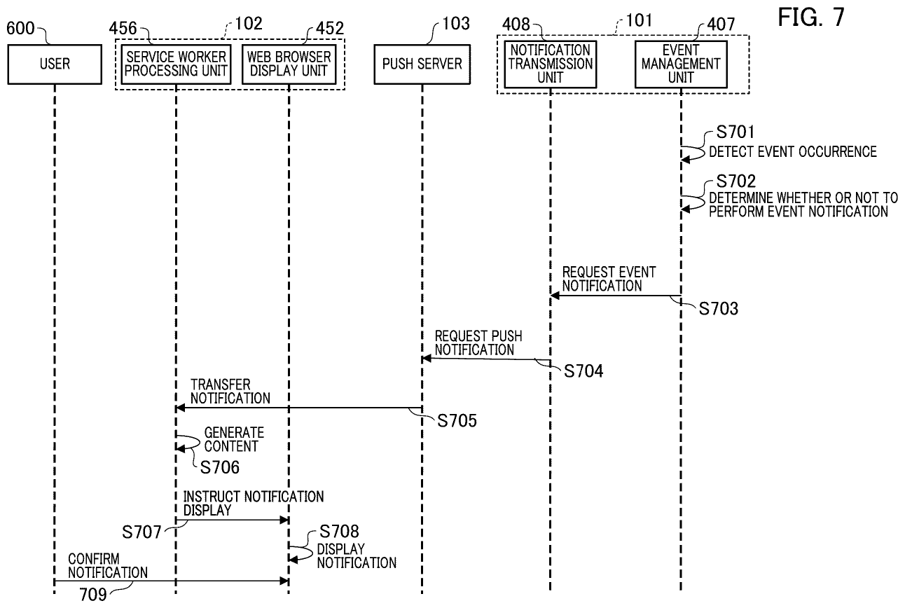

FIG. 7 is a sequence diagram for push notifications in the device management PWA. Here, it is assumed that the device management PWA of the image forming apparatus 101 has been installed in the information terminal 102 by the processing shown in FIG. 6, and that the information terminal 102 has been registered in the push server 103 as a push notification target of the image forming apparatus 101. Each processing that is executed by the image forming apparatus 101 in FIG. 7 is realized by the CPU 201 reading a program and the like stored in the ROM 202, and executing the program. Each processing that is executed by the information terminal 102 in FIG. 7 is realized by the CPU 301 reading a program or the like stored in the ROM 303, and executing the program. Each processing that is executed by the push server 103 in FIG. 7 is implemented by the CPU 351 reading a program and the like stored in the ROM 353, and executing the program.

The processing for transmitting a push notification is begun by the event management unit 407 of the image forming apparatus 101 after being triggered by the occurrence of some event (for example, occurrence of an error) in the image forming apparatus 101. In step S701, the event management unit 407 of the image forming apparatus 101 detects the occurrence of an event in the image forming apparatus 101. In step S702, the event management unit 407 determines whether or not the detected event is a target for notification to the device management PWA. In a case in which it is determined that the detected event is a target for notification to the device management PWA, the event management unit 407 performs the processing for step S703.

In step S703, the event management unit 407 requests the notification transmission unit 408 to transmit a notification for the occurrence of an event regarding the detected event. In step S704, the notification transmission unit 408 transmits, to the push server 103, an event occurrence notification request in order to perform notification of event occurrence to the information terminal 102, which is registered as a notification destination. At this time, the notification transmission unit 408 provides the push server 103 with the contents of the event that has occurred, together with a notification request. The contents of the event that has occurred is, for example, that a problem has occurred in which a FAX cannot be transmitted. Thus, in a case in which an event that is a notification target occurs in the image forming apparatus 101, a notifying process for causing the PWA of the information terminal 102 to perform notification of information regarding the image forming apparatus 101 is performed via a push service.

Upon receiving a notification request from the notification transmission unit 408 of the image forming apparatus 101, the push server 103, which provides a push service, performs the processing for step S705. In step S705, the push server 103 transfers the notification information that has been requested by the notification transmission unit 408 of the image forming apparatus 101 to the information terminal 102 that is registered, in the push server 103, as a notification target for notifications from the image forming apparatus 101.

The Service Worker processing unit (hereinafter referred to as an SW processing unit) 456 of the information terminal 102 that has received the notification of the occurrence of an event in the image forming apparatus 101 from the push server 103 performs the processing for step S706. In step S706, the SW processing unit 456 generates push notification contents to be displayed on the web browser display unit 452 of the information terminal 102 based on the notification that was received from the image forming apparatus 101 via the push server 103.

The SW processing unit 456 dynamically generates notification content to be displayed in the PWA based on information regarding the image forming apparatus 101 that is included in the notification that was received from the image forming apparatus 101. That is, the SW processing unit 456 dynamically generates corresponding contents in accordance with the event that has occurred in the image forming apparatus 101 that is indicated by the notification. An example of push notification contents that are generated by the SW processing unit 456 is shown in Table 1. Table 1 shows an example of push notification contents that are generated by the SW processing unit 456 in a case in which a problem occurs in the image forming apparatus 101 in which a FAX cannot be transmitted.

TABLE 1

| Title | Problem occurs |
|---|---|
| Message | Fax could not be transmitted. |
| | Please check the details. |
| Link destination | (A URL of a screen that provides response |
| for when tapped | information for a problem in which a fax cannot |
| | be transmitted in the image forming apparatus 101) |

The push notification content generated by the SW processing unit 456 includes, for example, a notification title that is displayed in the notification, a message indicating the notification contents that is displayed in a notification, and information for a link destination for when the notification is tapped by the user. The SW processing unit 456 sets information indicating what kind of event has occurred in each of the title and the message. Note that although in the present embodiment, a case in which the SW processing unit 456 generates both a title and a message is explained as an example, there may also be cases in which just one of a title and a message is generated as the contents indicating the notification contents. Additionally, according to the event that has been received, the SW processing unit 456 generates, as a link destination when the notification is tapped, a URL for a page that is related to the event that has been received, such as a page in which information to be referred to regarding the event that has occurred is described. Note that although in the present embodiment, an example in which a URL that is generated by the SW processing unit 456 is accessed when a notification is tapped is explained, a URL that is generated by the SW processing unit 456 may be displayed in a body text of the notification together with the message, and the URL may be accessed in a case in which the URL is tapped.

In step S707, the SW processing unit 456 instructs the web browser display unit 452 of the information terminal 102 to display a push notification from the image forming apparatus 101. The SW processing unit 456 instructs the web browser display unit 452 to display the push notification using the push notification contents that were generated in step S706. In step S708, the web browser display unit 452 displays the contents of the push notification on the input/output device 308 of the information terminal 102.

In step S709, the user confirms the notification from the image forming apparatus 101 that is being displayed on the information terminal 102. Additionally, when the user taps the notification, while this is being tapped, a screen for a link destination is displayed by the PWA on the input/output device 308 of the information terminal 102. When the information terminal 102 detects that the user has tapped the notification, the information terminal 102 displays the link destination that has been set as the contents of the notification. Accordingly, by tapping the notification only once, the user can display a screen in which information that is useful as a reference for the event that has occurred is described.

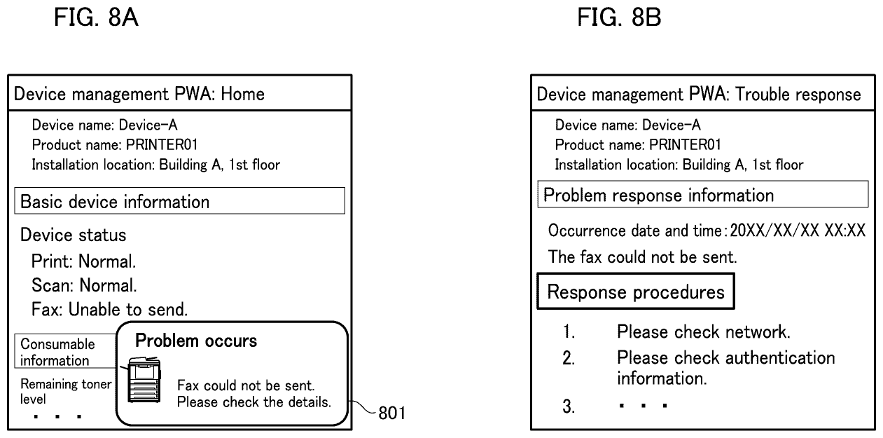

A UI of a device management PWA will be explained with reference to FIG. 8A to FIG. 10B. FIG. 8A to FIG. 10B are diagrams illustrating examples of a UI of the device management PWA. FIG. 8A is a diagram showing an example of a notification in a case in which a problem occurs in which a FAX cannot be transmitted. FIG. 8A illustrates an example in which a notification is displayed while the home screen of the device management PWA is being viewed, and a push notification 801 is displayed so as to be superimposed on the home screen. The push notification 801 is an example of a notification that is received from the image forming apparatus 101. Upon receiving, from the image forming apparatus 101, a notification indicating that a problem has occurred in which a FAX cannot be transmitted, the SW processing unit 456 generates the push notification contents, and the push notification 801 is displayed. When generating the push notification contents, the SW processing unit 456 also generates a link to be accessed when the push notification is tapped, in accordance with the event that has been received. The contents of the push notification 801 correspond to Table 1. In the push notification 801, “A Problem has Occurred” is displayed as the title, and “Fax cannot be transmitted. Please check details.” is displayed as the message. Additionally, when the push notification 801 is tapped by the user, the information terminal 102 accesses the URL that has been set as a link when the push notification is tapped and displays a screen that provides corresponding information for a problem in which a fax cannot be transmitted by the image forming apparatus 101. FIG. 8B is a diagram illustrating an example of a UI of a transition destination that is displayed when the push notification 801 is tapped. In the UI of the transition destination in a case in which the push notification 801 is tapped by the user, a page of response procedures for the problem in which a fax cannot be transmitted is displayed.

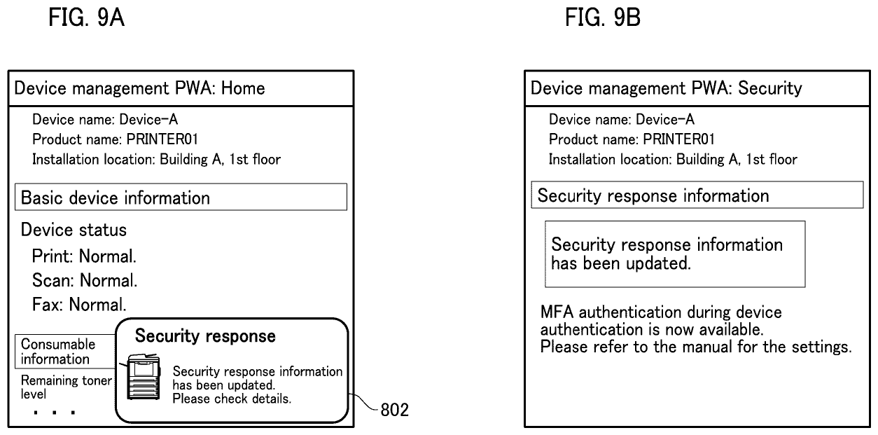

FIG. 9A is a diagram illustrating an example of a notification in a case in which a security response event has occurred. A push notification 802 is an example of a notification that has been received from the image forming apparatus 101. Upon receiving, from the image forming apparatus 101, a notification indicating that a security response event has occurred, push notification contents are generated by the SW processing unit 456, and the push notification 802 is displayed. When generating the push notification contents, the SW processing unit 456 also generates a link to be accessed when the push notification is tapped, in accordance with the event that has been received. In the push notification 802, “Security Response” is displayed as the title, and “Security response information has been updated. Please check details.” is displayed as the message. Additionally, when the push notification 802 is tapped by the user, the information terminal 102 accesses a URL that has been set as the link to be accessed when the push notification is tapped, and displays a screen providing information regarding the security response in the image forming apparatus 101. FIG. 9B is a diagram illustrating an example of a UI of a transition destination that is displayed in a case in which the push notification 802 is tapped. In a case in which the push notification 802 is tapped by a user, a page describing the response procedures for the security response is displayed in the UI of the transition destination.

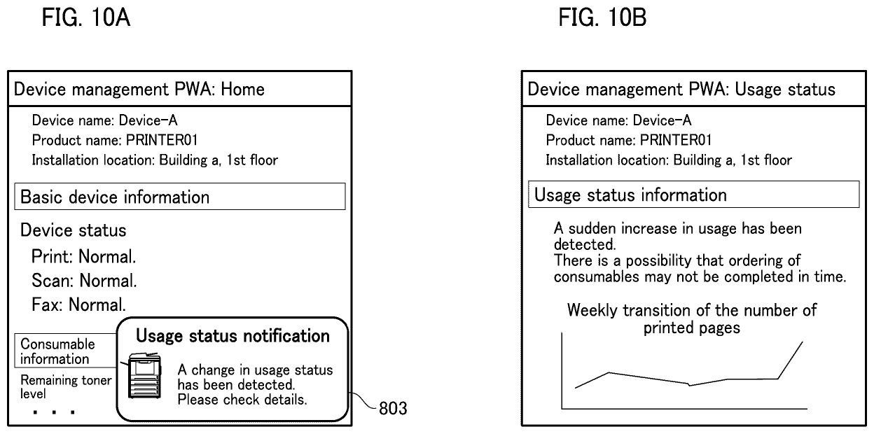

FIG. 10A is a diagram illustrating an example of a notification in a case in which an event regarding a change in usage status occurs. A push notification 803 is an example of a notification that has been received from the image forming apparatus 101. Upon receiving, from the image forming apparatus 101, a notification indicating that an event regarding a change in usage status has occurred, push notification contents are generated by the SW processing unit 456, and the push notification 803 is displayed. When generating the push notification contents, the SW processing unit 456 also generates a link to be accessed when the push notification is tapped, in accordance with the event that has been received. In the push notification 803, “Information on Usage Status” is displayed as the title, and “A change in usage status has been detected. Please check details.” is displayed as the message. Additionally, when the push notification 803 is tapped by the user, the information terminal 102 accesses the URL that has been set as the link to be accessed when the push notification is tapped, and displays a screen providing information regarding the usage status of the image forming apparatus 101. FIG. 10B is a diagram illustrating an example of a UI of a transition destination that is displayed in a case in which the push notification 803 is tapped. A page providing information regarding the usage status of the image forming apparatus 101 is displayed in the UI of the transition destination that is displayed in a case in which the push notification 803 is tapped by the user.

Thus, upon receiving an event from the image forming apparatus 101, the SW processing unit 456 of the information terminal 102 generates a link destination corresponding to the event together with a notification title and a message based on the received event, and causes a push notification to be displayed. Then, when the push notification is tapped, the link destination corresponding to the event is accessed, and a page relevant to the received event is displayed on the information terminal 102. By the SW processing unit 456 dynamically generating contents including a URL to be accessed when the push notification is tapped, the screen to which transition occurs by tapping the push notification is switched according to the event that has occurred. Note that although FIG. 8A to FIG. 10B illustrate examples in which an event is received and a push notification is displayed while a home screen of the device management PWA is being viewed, a push notification can be received, and a screen can be displayed even at a timing when the device management PWA is not being viewed.

As described above, according to the present embodiment, the user can be notified by push notification of events that have occurred in the network device, and the contents configuring the push notification can be dynamically generated according to the event that has occurred. By including, in the contents configuring the push notification, a URL for transitioning to a page that is relevant to the event, a transition to the relevant page is enabled when the push notification is tapped. Accordingly, in device management utilizing PWA technology, a page relevant to an event can be displayed simply by tapping a notification, and the convenience of event notification relating to device management utilizing a PWA is improved. Note that the present embodiment can also be realized by a PWA program that is installed and executed on a computer of the information terminal 102 by accessing a website that is provided by a network device, which is the image forming apparatus 101.

### Embodiment 2

In the first embodiment, when the contents according to the push notification are generated, a URL is included for transitioning to a screen corresponding to the event that served as the trigger for the push notification, thereby enabling a screen corresponding to the event to be displayed by tapping the push notification. Therefore, the first embodiment is based on the premise that a screen corresponding to an event serving as a trigger for a push notification exists. For example, it is assumed that, for an event in which the problem that a fax cannot be transmitted occurs, there is a screen corresponding to the occurrence of the problem that a fax cannot be transmitted. However, for an event occurring in a device, there may be cases in which a corresponding screen is not present in the device management service. Additionally, cases are also assumed in which it is desired to limit screens to which a transition is permitted depending on user authority, and in which it is desired to fix a screen to which a transition occurs by tapping a push notification. Therefore, in the present embodiment, the screen to which a transition occurs when a push notification is tapped can be set by a user.

Specifically, in the present embodiment, as a transition destination when a push notification is tapped, transition to a top page of a device management screen, and a screen for notification management can be selected, in addition to an individual screen corresponding to an event (a problem response screen in a case in which a problem has occurred). The top page of the device management screen is a screen that serves as an entrance to a device management service. The screen for notification management is a screen in which a list of notifications that have been received by the device management service and details thereof can be confirmed.

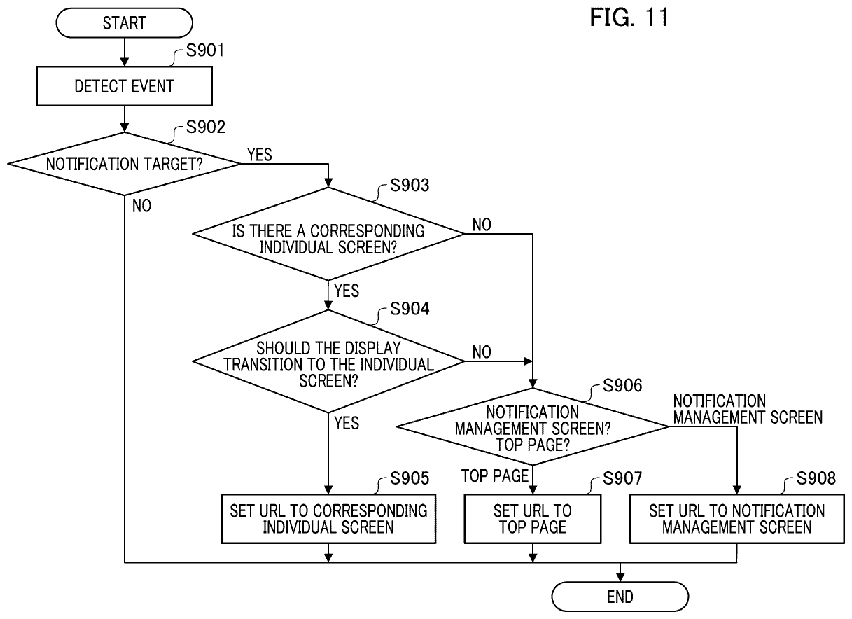

FIG. 11 is a flowchart illustrating a URL setting process for push notifications in the second embodiment. Each processing that is executed by the image forming apparatus 101 in FIG. 11 is realized by the CPU 201 reading and executing a program and the like stored in the ROM 202. Each processing that is executed by the information terminal 102 in FIG. 11 is realized by the CPU 301 reading and executing a program and the like stored in the ROM 303.

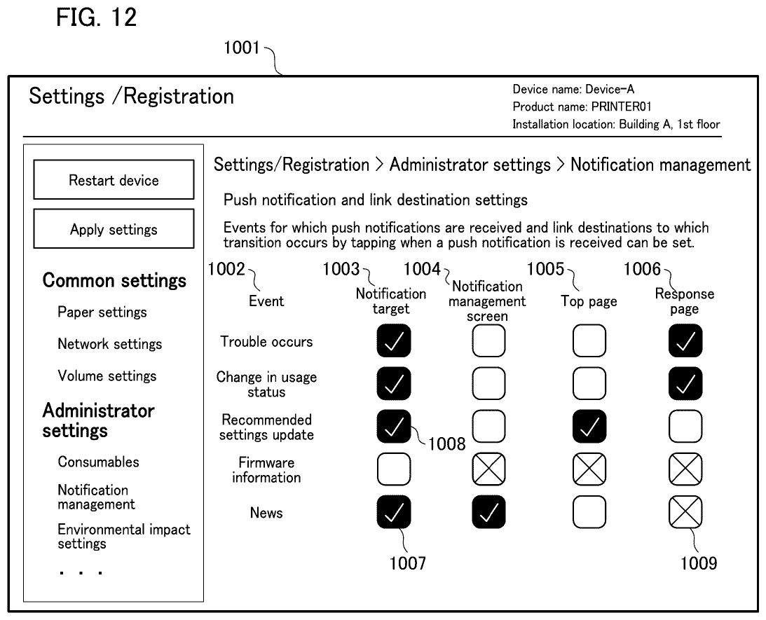

In step S901, the image forming apparatus 101 detects the occurrence of an event in the device. In step S902, the image forming apparatus 101 determines whether or not the event that has occurred is a target of push notifications based on the notification management settings. The notification management settings are set in advance by the user. Details of the notification management settings will be described below with reference to FIG. 12. In a case in which it is determined that the event is not a target of push notifications, the image forming apparatus 101 ends the present processing. In contrast, in a case in which it is determined that the event is a target of push notifications, the image forming apparatus 101 performs a push notification to the SW processing unit 456 of the information terminal 102 via the push service. The SW processing unit 456 that has received the notification from the image forming apparatus 101 performs the processing for steps S903 to S908 in order to generate a URL that serves as access information corresponding to a screen to be transitioned to when the notification is performed.

In S903, the SW processing unit 456 determines whether or not there is an individual screen corresponding to the event that has occurred. Whether or not there is an individual screen corresponding to the event that has occurred is determined, for example, according to a type of the event for which the notification is performed. In a case in which it is determined that there is an individual screen corresponding to the event that has occurred, the processing for step S904 is performed. In contrast, in a case in which it is determined that there is no individual screen corresponding to the event that has occurred, the processing for step S906 is performed.

In step S904, the SW processing unit 456 determines whether or not to transition to an individual screen corresponding to an event that has occurred based on the notification management settings. In a case in which it is determined that a transition will be performed to the individual screen corresponding to the event that has occurred, the processing for step S905 is performed. In contrast, in a case in which it is determined that a transition to the individual screen corresponding to the event that has occurred will not be performed, the processing for step S906 is performed. In step S905, the SW processing unit 456 sets a URL of the corresponding individual screen as a transition destination when a push notification is tapped.

In a case in which it has been determined in step S903 that there is no corresponding individual screen, or in a case in which it has been determined in step S904 that transition will not be performed to the individual screen, the processing for step S906 is performed. In step S906, the SW processing unit 456 determines whether a transition destination for when a push notification is tapped should be a notification management screen or a top page, based on the notification management settings. In a case in which it is determined that the transition destination for when a push notification is tapped should be the notification management screen, the processing for step S908 is performed. In contrast, in a case in which it is determined that the transition destination for when a push notification is tapped should be the top page, the processing for step S907 is performed. In step S907, the SW processing unit 456 sets the URL of the top page as the transition destination for when the push notification is tapped. In step S908, the SW processing unit 456 sets the URL of the notification management screen as the transition destination when the push notification is tapped.

Note that although in the present embodiment, an example is explained in which the processing for steps S901 and S902 is executed by the image forming apparatus 101 and the processing for steps S903 to S908 is executed by the information terminal 102, the present disclosure is not limited thereto. For example, it may also be made such that the image forming apparatus 101 executes the processing for steps S901 to S908, that the URL of the transition destination for when a push notification is tapped is included in a notification from the image forming apparatus 101, and that the SW processing unit 456 generates the notification contents in accordance with the URL that is included in the notification. Additionally, the SW processing unit 456 of the information terminal 102 may execute the processing for steps S901 to S908. Upon detecting reception of an event from the image forming apparatus 101 in step S901, the SW processing unit 456 determines whether or not the event is a notification target in accordance with the notification settings. In a case in which the event is a notification target, the SW processing unit 456 determines, according to the notification settings, a screen to be set as the transition destination for when the push notification is tapped. In contrast, in a case in which the event is not a notification target, the SW processing unit 456 does not display the push notification that has been received from the image forming apparatus 101 on the input/output device 308 of the information terminal 102, and the user is thereby not notified.

FIG. 12 is a diagram illustrating an example of a UI of a setting screen for notification management in the second embodiment. A setting screen 1001 is a screen for the user utilizing the device management service to perform settings regarding the push notification. On the setting screen 1001, for each type of event, settings for whether or not the event is a notification target and settings for a link destination screen to which a transition occurs when a notification is tapped, in a case in which the event is the notification target, can be performed. As a link destination screen to which a transition occurs when a notification is tapped, for example, an individual screen corresponding to an event that has occurred (a response page), a top page, or a notification management screen can be set. Note that a screen that can be set as the link destination screen to which a transition occurs when a notification is tapped is not limited thereto.

Although in the present embodiment, a case is explained as an example in which an application server of the image forming apparatus 101 provides the setting screen 1001 to the PWA of the information terminal 102, and the PWA receives settings from the user, the present disclosure is not limited thereto. For example, a device management server (not illustrated) that provides a device management service may provide the setting screen 1001. Contents that are set on the setting screen 1001 are stored in each of the image forming apparatus 101 and the information terminal 102 as notification management settings and are referred to during the notification process.

The setting screen 1001 includes device information, an event 1002, a notification target 1003, a notification management screen 1004, a top page 1005, and a response page 1006. In the device information, information indicating that a device that is a target of the notification settings, such as a device name, a product name, and a setup location, is displayed. In the column of the event 1002, event classes (types of events) that occur on the network device and that can be made targets of the push notifications in the device management service are listed. The setting screen 1001 has a matrix configuration in which rows for the notification target 1003, the notification management screen 1004, the top page 1005, and the response page 1006 are prepared for each type of event.

In the notification target 1003, whether or not to provide a notification to the user for an event in the column of the event 1002, that is, whether or not to designate the event as a target of the push notifications, is set. In a case in which the user designates an event as a target of the push notifications, the user sets a check box of the notification target 1003 to an ON state. In contrast, in a case in which the user does not designate an event as a target of the push notifications, the user sets a check box of the notification target 1003 to an OFF state. In FIG. 12, a checkbox 1007 indicates an ON state of a checkbox, and a check box 1008 indicates an OFF state of a checkbox.

For an event that has been set as a target of the push notifications in the notification target 1003, any one of the notification management screen 1004, the top page 1005, and the response page 1006 is set as a screen to be accessed when the notification is tapped. For an event for which the notification management screen 1004 has been selected, by tapping the push notification, a transition occurs to a list of events of which the device management service has been notified. For an event for which the top page 1005 is selected, by tapping the push notification, transition occurs to a top page of a device management service. For an event for which the response page 1006 is selected, by tapping the push notification, a transition occurs to a screen corresponding to the event that has occurred and for which notification has been performed. The setting for the response page 1006 is referred to when the determination is made in step S904. The setting for the top page 1005 is referred to when the determination is made in step S906. Thus, in the present embodiment, a URL that is accessed when a notification is tapped is generated according to a setting of a screen to be accessed when the user taps a notification for information regarding the image forming apparatus 101 based on a notifying process that has been set by the user.

On the setting screen 1001, the check boxes for items that cannot be selected are deactivated. For example, since there is no corresponding screen for a “News” event, a check box in a row of the response page 1006 becomes a deactivated checkbox 1009 indicating a deactivated state. Additionally, in a case in which an event that has occurred is not designated as a notification target, the transition destination for when the push notification is tapped cannot be selected. Therefore, in the example on the setting screen 1001, for an event relating to “Firmware Information”, which is not designated as a notification target, all checkboxes for the notification management screen 1004, the top page 1005, and the response page 1006 are in the state of the deactivated check box 1009.

Through the above processing, a user can set a screen to which transition will occur in a case in which a push notification regarding device management from the image forming apparatus 101 is tapped. When the SW processing unit 456 of the information terminal 102 generates a notification to be displayed in a PWA, the SW processing unit 456 generates access information for a screen to which transition will occur in a case in which the push notification is tapped, according to settings by a user. When the push notification is tapped, based on the generated access information, the screen for the transition destination that has been set by the user can be displayed. Note that the present embodiment can also be realized by a PWA program that is installed and executed in a computer of the information terminal 102 by accessing a website that is provided by a network device that is the image forming apparatus 101.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions

This application claims the benefit of Japanese Patent Application No. 2025-043873, filed Mar. 18, 2025, which is hereby incorporated by reference herein in its entirety.

What is claimed is:

1. A network device that provides a website including information for the network device itself, the network device comprising:
a memory storing instructions; and
a processor executing the instructions causing the network device to:
provide, to a terminal that has accessed the website, an application having at least a portion of functions of the website; and
execute a notification process for causing the application installed in the terminal to provide notifications for information regarding the network device via a push service,
wherein the application provided by the network device is a progressive web application for managing the network device, and in the application, access information corresponding to a screen to be accessed in a case in which a notification for information regarding the network device based on the notifying process is tapped is generated based on information regarding the network device included in the notification.

2. The network device according to claim 1, wherein, in the terminal, in a case in which the application is installed, a Service Worker corresponding to the application is registered in a browser, and contents of a notification to be displayed in the application including the access information are generated by the Service Worker.

3. The network device according to claim 2, wherein, in the application, as the contents of the notification generated by the Service Worker, a title of the notification or a message indicating the contents of the notification to be displayed in the notification and the access information are generated based on information regarding the network device included in the notification.

4. The network device according to claim 1, wherein, in the application, the access information is generated according to a setting corresponding to a screen to be accessed in a case in which a notification for information regarding the network device based on the notifying process set by a user is tapped.

5. The network device according to claim 1, wherein, any one of an individual screen corresponding to the notified event, a top page of a device management screen, and a notification management screen is set as the screen to be accessed in a case in which notification of information regarding the network device based on the notifying process is tapped.

6. The network device according to claim 1, wherein, in the application, for each type of event, the application receives a setting as to whether or not to provide a user with a notification by displaying a notification received from the network device on a display of the terminal, and, in a case in which the user is to be notified, a setting of a screen to be accessed in a case in which the notification providing information relating to the network device based on the notifying process is tapped.

7. A control method of a network device that provides a website including information for the network device itself, the method comprising:
providing an application having at least a portion of functions of the website to a terminal that has accessed the website; and
executing a notifying process for causing the application installed in the terminal to provide notifications for information regarding the network device via a push service,
wherein the application provided by the network device is a progressive web application for managing the network device, and in the application, access information corresponding to a screen to be accessed in a case in which a notification for information regarding the network device based on the notification processing is tapped is generated, based on information regarding the network device included in the notification.

8. A non-transitory storage medium storing a program that is installed in and executed by a computer by accessing a website provided by a network device, the program causing the computer to perform each step of a control method, the method comprising:
receiving a request for notifications for information regarding the network device from the network device via a push service; and
generating access information corresponding to a screen to be accessed in a case in which a notification for information regarding the network device is tapped, based on information regarding the network device included in the notification.
